(19) United States
(12) Patent Application Publication
(10) Pub. No.: US 2011/0242058 A1
(43) Pub. Date: Oct. 6, 2011

(54) Display panel including a soft key

(76) Inventors: Choon-Hyop Lee, Yongin-City (KR); Sung-Ku Kang, Yongin-city (KR); Jung-Mok Park, Yongin-city (KR); Do-Ok Park, Yongin-city (KR)

(21) Appl. No.: 12/926,793

(22) Filed: Dec. 9, 2010

(30) Foreign Application Priority Data
Apr. 1, 2010 (KR) 10-2010-0029948

(51) Int. Cl. G06F 3/042

(52) U.S. Cl. 345/176

(57) ABSTRACT

A display panel includes a transparent substrate, a picture region, a black matrix region around the picture region, and a soft key region, a black matrix formed in the black matrix region on one side of the transparent substrate and having a first opening in the soft key region, an overcoating layer on the transparent substrate including the black matrix, and a metal pattern on the overcoating layer, the metal pattern overlapping the first opening, the metal pattern including a second opening having a smaller area than the first opening, and partially exposing the first opening, wherein a soft key is implemented in the soft key region by disposing a light source under the first opening and the second opening. When the display panel is a touch screen panel, conductive sensing cells in the picture region and position detection lines in the black matrix region are included.

### BACKGROUND

1. Field

Embodiments relate to a panel, more particularly, to a touch screen panel, that includes a soft key.

2. Description of the Related Art

A touch screen panel is an input device that selects contents displayed on a screen, e.g., an image display device, etc., using a person's hand or an object to input commands of a user. The touch screen panel is provided on a front face of the image display device and converts positions on the touch screen panel directly contacting the person's hand or object into electrical signals. Accordingly, the instruction selected at the contact position is received as an input signal. As the touch screen panel can replace a separate input device that is operated by being connected with the image display device, e.g., a keyboard or a mouse, the use field of the touch screen panel is being expanded gradually.

The touch screen panel includes sensing cells in a picture region that recognize a touch event in the picture region. That is, in an image display device equipped with a touch screen panel, a picture region is a display region that displays images and a touch active region through which a touch input is possible.

Soft keys, such as a function key or a volume key, may be provided at one side of the picture region for convenience. Soft keys may be formed by specific coating, printing, or attaching film. However, an additional process is required to form the soft key, such that the manufacturing process and cost are increased.

### SUMMARY

Embodiments are therefore directed to a touch screen panel and associated methods of manufacturing the same, which substantially overcomes one or more of the problems due to the limitations and disadvantages of the related art.

It is therefore a feature of an embodiment to provide a touch screen panel having a soft key that may be formed without a specific additional process being required.

It is therefore another feature of an embodiment to provide a touch screen panel having a soft key that may have its brightness readily adjusted by adjusting one of the number, size, and/or shape of first and second openings between a soft key on a touch surface and a light source for realizing the soft key.

It is yet another feature of an embodiment to provide a touch screen panel having a soft key realized using various reflective ratios and colors by selecting a material in consideration of the color of reflection of the metal pattern, thereby allowing free design.

It is still yet another feature of an embodiment to provide, when the transparent substrate of the touch screen panel is integrally formed with the window substrate of an image display device equipped with the touch screen panel, a touch screen display device having a reduced thickness.

At least one of the above and other features and advantages may be realized by providing a touch screen panel, which includes a transparent substrate where a picture region, a black matrix region around the picture region, and a soft key region disposed in a portion of the black matrix region are defined, a black matrix formed to correspond to the black matrix region on one side of the transparent substrate and having a first opening in the soft key region; an overcoating layer formed on one side of the transparent substrate including the upper portion of the black matrix, a plurality of conductive sensing cells formed at least in the picture region on the overcoating layer, position detection lines formed in the black matrix region on the overcoating layer and connected with the conductive sensing cells, and a metal pattern made of the same material on the same layer as the position detection lines, disposed inside the first opening, having a second opening having a smaller area than the first opening, and partially exposing the first opening, in which a soft key is implemented in the soft key region by disposing a light source under the first opening and the second opening.

The first opening may include a single opening for the soft key and a plurality of the second openings may overlap the first opening.

The first opening may include a plurality of the first openings for the soft key and one or more of the second openings may overlap each of the first openings.

The soft key may function as a semi-transmissive type key by transmitting light from the light source through the first and second openings, in a first mode where the light source emits light.

The metal pattern may be made of a reflective metal, and the soft key may function as a reflective type by reflecting external light from the metal pattern exposed between the first opening and the second opening, in a second mode where the light source does not emit light.

The touch screen panel as may further include one or more conductive sensing cells made of the same material on the same layer as the conductive sensing cells in the picture region, the one or more conductive sensing cells being in the soft key region on the overcoating layer.

The light source may be a backlight of a liquid crystal display device disposed under the touch screen panel or may be a specific light source for the soft key.

The transparent substrate may be a window substrate at an uppermost substrate in an image display device, and the black matrix, the overcoating layer, the conductive sensing cells, the position detection lines, and the metal pattern are formed on a lower surface opposite to a touch surface of the transparent substrate.

When more than one soft key is to be implemented in the soft key region, each of the soft keys may have a corresponding first opening.

At least one of the above and other features and advantages may be realized by providing a display panel, including a transparent substrate, a picture region, a black matrix region around the picture region, and a soft key region disposed in a portion of the black matrix region defined on the transparent substrate, a black matrix formed to correspond to the black matrix region on one side of the transparent substrate and having a first opening in the soft key region, an overcoating layer on one side of the transparent substrate including the upper portion of the black matrix, and a metal pattern on the overcoating layer, the metal pattern overlapping the first opening, the metal pattern including a second opening having a smaller area than the first opening, and partially exposing the first opening, wherein a soft key is implemented in the soft key region by disposing a light source under the first opening and the second opening.

Accordingly, the first opening corresponding to the soft key is formed in the black matrix disposed around the picture region, and the metal pattern which has the second opening having a smaller area than the first opening and which exposes the first opening is made of the same material on the same layer as the position detection lines and overlaps the first opening. Further, by disposing the light source under the first and second openings, the soft key is formed in the process of forming the black matrix of the touch screen panel and the process of forming the position detection lines. Accordingly, manufacturing processing may be simplified and manufacturing cost may be reduced.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic plan view of an example of a touch screen panel;

FIG. 2 illustrates a plan view and a cross-sectional view of the touch screen panel according to an embodiment;

FIG. 3 illustrates a plan view of a touch screen panel according to another embodiment; and

FIG. 4 illustrates a plan view and a cross-sectional view showing the touch screen panel according to various embodiments.

### DETAILED DESCRIPTION

Korean Patent Application No. 10-2010-0029948, filed on Apr. 1, 2010, in the Korean Intellectual Property Office, and entitled: “Touch Screen Panel” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

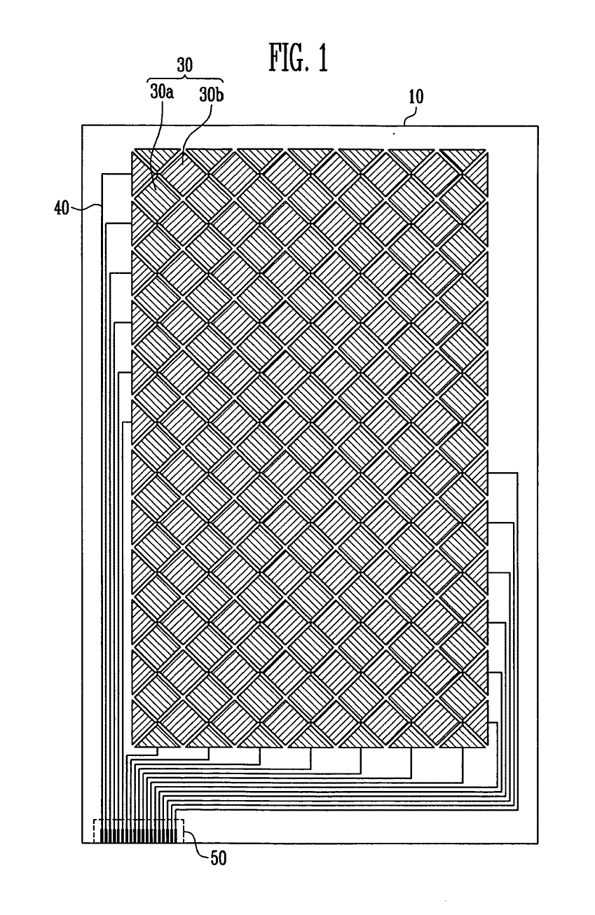

FIG. 1 illustrates a schematic plan view of an example of a touch screen panel. Referring to FIG. 1, a touch screen panel may include a transparent substrate 10, a plurality of conductive sensing cells 30 formed on the transparent substrate 10, and position detection lines 40 connecting the conductive sensing cells 30 with an external driving circuit through a pad unit 50.

The transparent substrate 10, serving as a base member of the touch screen panel, may be formed of a transparent substrate material, e.g., polyethylene terephthalate (PET) or an acryl. The adjective “transparent” inclusively means 100% transparency and high transmittance in the visible region, i.e., a material suitable for use as a display window.

The conductive sensing cells 30 may be made of a transparent electrode material, e.g., indium-tin-oxide (ITO), in a touch active region at one side of the transparent substrate 10. The conductive sensing cells 30 may include first sensing cells 30a connected in a first direction and second sensing cells 30b connected in a second direction, orthogonal to the first direction.

The first sensing cells 30a may be connected with each other in the first direction, e.g., in the column direction, and connected with the position detection lines 40 in each column. The second sensing cells 30b may be connected with each other in a second direction different from the first direction, for example, the row direction, between the first sensing cells 30a to be insulated from the first sensing cells 30a, and are connected with the position detection lines 40 in each row.

The first sensing cells 30a and the second sensing cells 30b may be respectively connected by first connecting patterns and second connecting patterns (not shown), with insulating layers therebetween, on the same layer, or may be disposed in different layers, with insulating layers therebetween.

The position detection lines 40 connect the sensing cells 30 with an external driving circuit (not shown), such as a position detection circuit, through the pad unit 50. The position lines 40 are disposed in a black matrix region at the edge portions of a touch screen panel without a touch active region where an image is displayed. Thus, as they are not in the display region, the position detection lines 40 may be made from a large selection of materials. For example, the position detection lines 40 may be made of a low-resistance material, such as Mo, Ag, Ti, Cu, Al, Mo/Al/Mo, and so forth, in addition to the transparent electrode material used for the sensing cells 30.

The touch screen panel described above is a capacitive type touch screen panel. When a contact object, e.g., a person's hand, a stylus pen, and so forth, contacts the touch screen panel, a change of electrostatic capacitance corresponding to the contact position is transmitted to the driving circuit (not shown) from the sensing cells 30 through the position detection lines 40 and the pad unit 50. The change in electrostatic capacity is converted into an electric signal by an X- and Y-input process circuit (not shown), such that a position of the contact is determined.

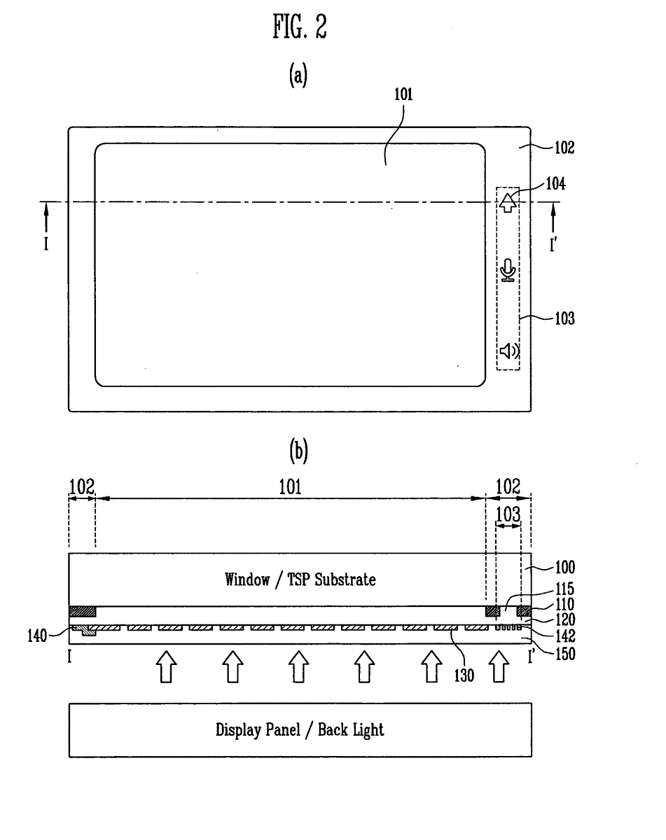

FIG. 2 illustrates a plan view (a) and a cross-sectional view (b) of the touch screen panel according to an embodiment. In FIG. 2, the plan view (a) schematically shows an image display device equipped with the touch screen panel according to the present embodiment. In FIG. 2, the cross-sectional view (b) schematically shows an example of a cross section taken along line I-I′ of the plan view (a). The display panel disposed under the touch screen panel may be implemented in various types, e.g., an organic light emitting display panel or a liquid crystal display panel. As the configuration of display panels is well known, a detailed description thereof is not provided.

As shown in the plan view (a) of FIG. 2, a transparent substrate 100 of the touch screen panel may be divided into picture region 101, a black matrix region 102 around the picture region 101, and a soft key region 103 disposed at a portion inside the black matrix region 102 at one side of the picture region 101.

As shown in the cross-sectional view (b) of FIG. 2, the touch screen panel according to the present embodiment may include the transparent substrate 100, a black matrix 110 along an edge, e.g., an entire periphery, of the transparent substrate 100, an overcoating layer 120 on the transparent substrate 100 including the upper portion of the black matrix 110, conductive sensing cells 130 on the overcoating layer 120, a position detection line 140 on the overcoating layer 120 and connected to the conductive sensing cells 130, a metal pattern 142, and a protective layer 150 formed on the transparent substrate 100 including upper portions of the conductive sensing cells 130, the position detection lines 140, and the metal pattern 142. These elements may be formed on a side of the transparent substrate 100 opposite a touch side, i.e., where contact for input is to occur.

In the particular embodiment described above, the transparent substrate 100 is to have components of the touch screen panel formed thereon, but embodiments are not limited thereto. Alternatively, the transparent substrate 100 may be a window substrate positioned as an uppermost substrate in the image display device employing the touch screen panel. In other words, an integrated touch screen panel, i.e., using the window substrate as the transparent substrate 100, may be implemented by forming patterns of the touch screen panel on the window substrate. Thus, a thickness of the image display device employing the touch screen panel may be reduced.

The touch screen panel according to the present embodiment also includes a soft key 104 formed in the soft key region 103. The soft key region 103 is defined in a portion of a black matrix region 102 where the black matrix 110 is formed. In the soft key region 103, an opening 115 is formed in a region of the black matrix 110 corresponding to the soft key 104. The metal pattern 142 may be disposed below the opening 115 of the black matrix 110, i.e. may completely overlap the opening 115 along a direction of illumination. The metal pattern 142 may be formed of a same material and the same time as the position detection line 140. The metal pattern 142 may be connected to the driving circuit.

The soft key 104 may be reflective or semi-transmissive and may be implemented by a light source under the metal pattern 142. The light source for the soft key 104 may be a light source on the display panel disposed under the touch screen panel, i.e., the back light of the liquid crystal display panel device, or a separate light source, e.g., a white or color light emitting diode (LED).

In this configuration, the picture region 101 is a display region that displays an image and a touch active region through which a touch input is possible. That is, the picture region 101 is a region corresponding to a pixel region of the display panel and a region where the conductive sensing cells 130 of the touch screen panel are disposed.

The soft key region 103 is disposed at a portion inside of the black matrix region 102 at one side of the picture region 101. The soft key 104 may be a function key, e.g., a menu key or a volume key, or a display key for displaying a specific symbol.

The black matrix 110 corresponds to the black matrix region 102 on one side of the transparent substrate 100. In particular, the black matrix 110 is disposed around the picture region 101 to overlap the patterns, such as the position detection lines 140, so these patterns are obscured form the viewing side. The black matrix 110 of the present embodiment has at least one opening 115 formed in a region corresponding to the soft key 104 formed in the soft key region 103. Openings 115 are formed to correspond to the soft keys 104 disposed in the soft key region 103, respectively. One opening 115 may be included in each soft key 104 or a plurality of separate openings 115 may be used for each soft key 104.

The overcoating layer 120 is formed on one side of the transparent substrate 100 including the upper portion of the black matrix 110. The overcoating layer 120 may be a transparent insulating substrate and may be formed over the entire surface of one side of the transparent substrate 100 including the upper portion of the black matrix 110.

Meanwhile, the conductive sensing cells 130 can be connected to the position detection lines 140 in each row or column. However, for the ease of description, connecting patterns that connect the conductive sensing cells 130 in each row or column and insulating layers disposed between the connecting patterns are not shown in FIG. 2.

The position detection lines 140 are formed in the black matrix region 102 on the overcoating layer 120 and connected with the conductive sensing cells 130, such that they transmit touch inputs from the conductive sensing cells 130 to the driving circuit (not shown).

The metal pattern 142 is made of the same material on the same layer as the position detection lines 140 in the soft key region 103 on the overcoating layer 120 in the process of forming the position detection lines 140. In particular, the metal pattern 142 is disposed under the first opening 115 of the black matrix 110 (to overlap the first opening in the region where the first opening 115 is formed) and has a second opening, i.e., portions where the metal is not present, having a smaller area than the first opening, thereby exposing a portion of the first opening. In other words, the metal pattern 142 blocks or reflects light that would be transmitted by the opening 115 in the black matrix 110.

The protective layer 150 is made of a transparent insulating material and may be formed over the entire surface of the transparent substrate 100 including the conductive sensing cells 130, the position detection lines 140, and the upper portion of the metal pattern 142.

In the present embodiment, a light source is disposed under the soft key region 103, i.e., under the first opening of the black matrix 110 and the second opening of the metal pattern 142, thereby implementing the soft key 104 in the soft key region 103.

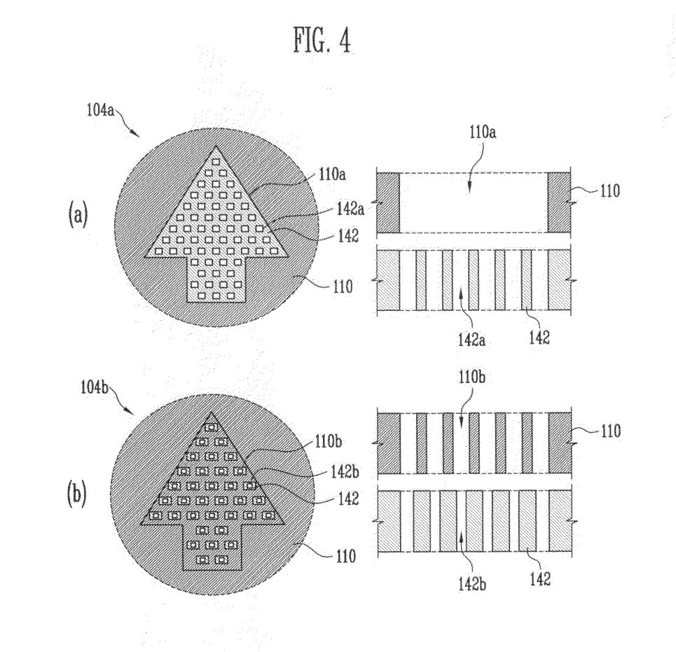

The first and second openings are formed to correspond to the soft keys 104 disposed in the soft key region 103, respectively, one first and/or second opening or a plurality of divided first and/or second openings may be provided for each soft key 104. This is described below in detail with reference to the embodiments shown in FIG. 4.

As the light source for implementing the soft key 104, a light source at the display panel disposed under the touch screen panel, for example, a backlight of a liquid crystal display device, may be used, or a light source for a soft key, such as a white or color LED (not shown) provided to implement the soft key 104 may be used.

According to the present embodiment, the first opening corresponding to the soft key 104 is formed in the black matrix 110 disposed around the picture region 101. The metal pattern 142, having a larger area than the first opening and which a portion is exposed through the first opening, is made of the same material on the same layer as the position detection lines 140 inside the first opening. While the metal pattern may be larger than the first opening, second openings in the metal pattern are smaller than the first opening and partially expose the first opening.

Further, by disposing the light source under the first and second openings, the soft key 104 is formed in the process of forming the black matrix 110 of the touch screen panel and the process of forming the position detection lines 140.

Accordingly, it is possible to simplify the manufacturing process and reduce the manufacturing cost.

In this configuration, a semi-transmissive soft key may be implemented by the light source under a low illumination of external light and a reflective soft key may be implemented by light reflected from the metal pattern 142 exposed between the first and second openings, when external light having luminance above a predetermined level.

Further, when the transparent substrate of the touch screen panel is integrally formed with the window substrate of an image display device equipped with the touch screen panel, it is possible to reduce the thickness of the image display device.

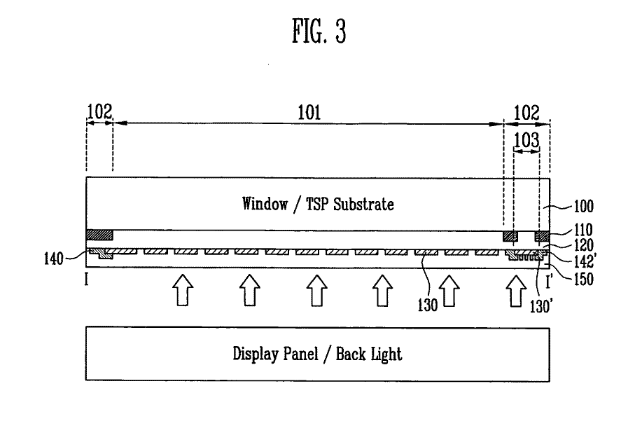

FIG. 3 illustrates a cross-sectional view of a touch screen panel in accordance with another embodiment. Only differences between the present embodiment and that of FIG. 2 will be discussed in detail below.

When the soft key 104 is to be a key receiving a touch input, e.g., a function key, the touch event may be sensed as an input signal by further forming one or more conductive sensing cells 130′ corresponding to the function key in the soft key region 103 on the overcoating layer 120, as shown in FIG. 3. That is, conductive sensing cells 130′ may be formed in the soft key region 103 as well as conductive sensing cells 130 in the picture region 101 on the overcoating layer 120. When the soft key 104 is to serve as a display key for displaying a specific symbol, the conductive sensing cell 130′ may not be disposed in the soft cell region 103.

A metal pattern 142′ may be formed at the same time as the position detection lines 140, i.e., after the conductive sensing cells 130 and 130′ have been formed. Therefore, the metal pattern 142′ overlies the conductive sensing cell 130′. As the conductive sensing cell 130′ may be connected to the driving circuit through the position detection lines 140, the metal pattern 142′ may not be connected to the driving circuit. Alternatively, when the conductive sensing cells 130′ are not provided in the soft key region 103, the metal pattern 142 can function as a sensing cell by itself, by connecting the metal pattern 142 with the driving circuit through a wire (not shown).

The conductive sensing cells 130′ formed in the soft key region 103 can be made of the same material on the same layer as in the process of forming the conductive sensing cells 130 on the picture region 101, thereby simplifying the manufacturing process.

Meanwhile, although it was shown in FIGS. 2 and 3 that the conductive sensing cells 130 and 130′ are formed on the overcoating layer 120 in the soft key region 103 and then the position detection lines 120 and the metal patterns 142 and 142′ are formed, the stacking order of the conductive sensing cells 130 and 130′, the position detection lines 140, and the metal patterns 142 and 142′ may be changed.

FIG. 4 illustrates a plan view and a cross-sectional view showing the touch screen panel according to various embodiments (a) and (b) of a soft key. Referring to (a) in FIG. 4, for a soft key 104a, the opening 115 in the black matrix 110 may include one opening 110a and the metal pattern 142 may include a plurality of second openings 142a. Referring to (b) in FIG. 4, for a soft key 104b, the opening 115 in the black matrix 110 may include a plurality of first openings 110b and the metal pattern 142 may include a plurality of second openings 142b. For example, as illustrated in (b), the second openings 142b disposed inside each first opening 110b may be narrower than and aligned with the first openings. In accordance with the embodiments illustrated in FIG. 4, the soft keys 104a and 104b may function as both a semi-transmissive type and a reflective type.

In detail, it is possible to implement a semi-transmissive soft key, using internal light emitted to the outside through the first openings 110a and 110b and the second openings 142a and 142b from the light source, by turning on the light source (not shown) disposed under the first openings 110a and 110b and the second openings 142a and 142b, under a condition in which illumination of light is low, such as in the night. That is, the soft keys 104 and 104b may be implemented (formed) in a semi-transmissive type by the internal light emitted from the light source in the first mode where the light source emits light.

Further, when external light having illumination above a predetermined level, such as in the day, it is possible to implement a reflective soft key using light that is created when light is transmitted through the first openings 110a and 110b is reflected from the metal pattern 142 exposed between the first openings 110a and 110b and the second openings 142a and 142b, without turning on the light source. That is, in a second mode where the light source does not emit light, the soft keys 104 and 104b may be implemented in a semi-transmissive type by light that is transmitted inside through the first openings 110a and 110b from the outside and the reflected from the metal pattern 142 exposed in the first openings 110a and 110b.

For these configurations, it is preferable that the metal pattern 142 is made of reflective metal having reflective ratio above a predetermined level, depending upon desired operational conditions. By using a material having a reflective ratio above a predetermined level, brightness of the soft keys 104a and 104b may be adjusted by adjusting the number, size, and shape of the first openings 110a and 110b and the second openings 142a and 142b to adjust the aperture ratio, i.e., area of an open region to area of each soft key region.

Further, it is possible to implement various reflective ratio and colors for the soft keys 104a and 104b by selecting a material in consideration of the color or reflective ratio of the metal pattern 142. Accordingly, it is possible to freely design the product.

Although an image display device having a built-in touch screen panel equipped with a soft key was described above as an embodiment for exemplifying a soft key that can be implemented as a function key, example embodiments are not limited thereto.

For example, the spirit of the present invention, which implements a semi-transmissive or reflective soft key by forming the first opening in the first black matrix formed around the picture region, forming the metal pattern partially exposed and having the second opening under the first opening, and disposing the light source under the first and second openings, may be applied to an image display device without a built-in touch screen panel.

For example, it is possible to implement a semi-transmissive or reflective soft key according to the present invention, by forming an opening in the black matrix formed on the upper substrate or the window substrate of a liquid crystal display device or an organic light emitting display device without a built-in touch screen panel.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A touch screen panel, comprising:
a transparent substrate;
a picture region, a black matrix region around the picture region, and a soft key region disposed in a portion of the black matrix region defined on the transparent substrate;
a black matrix corresponding to the black matrix region on one side of the transparent substrate and having a first opening in the soft key region;
an overcoating layer on one side of the transparent substrate including the upper portion of the black matrix;
a plurality of conductive sensing cells at least in the picture region on the overcoating layer;
position detection lines formed in the black matrix region on the overcoating layer and connected with the conductive sensing cells; and
a metal pattern made of the same material on the same layer as the position detection lines, the metal pattern overlapping the first opening and including a second opening having a smaller area than the first opening, the metal pattern partially exposing the first opening,
wherein a soft key is implemented in the soft key region by disposing a light source under the first opening and the second opening.

2. The touch screen panel as claimed in claim 1, wherein the first opening includes a single opening for the soft key, and a plurality of the second openings overlaps the first opening.

3. The touch screen panel as claimed in claim 1, wherein the first opening includes a plurality of the first openings for the soft key and one or more of the second openings overlap each of the first openings.

4. The touch screen panel as claimed in claim 1, wherein the soft key functions as a semi-transmissive type key by transmitting light from the light source through the first and second openings, in a first mode where the light source emits light.

5. The touch screen panel as claimed in claim 1, wherein the metal pattern is made of a reflective metal, and the soft key functions as a reflective type by reflecting external light from the metal pattern exposed between the first opening and the second opening, in a second mode where the light source does not emit light.

6. The touch screen panel as claimed in claim 1, further comprising one or more conductive sensing cells made of the same material on the same layer as the conductive sensing cells in the picture region, the one or more conductive sensing cells being in the soft key region on the overcoating layer.

7. The touch screen panel as claimed in claim 1, wherein the light source is a backlight of a liquid crystal display device disposed under the touch screen panel.

8. The touch screen panel as claimed in claim 1, wherein the light source is a specific light source for the soft key.

9. The touch screen panel as claimed in claim 1, wherein the transparent substrate is a window substrate at an uppermost substrate in an image display device, and the black matrix, the overcoating layer, the conductive sensing cells, the position detection lines, and the metal pattern are formed on a lower surface opposite to a touch surface of the transparent substrate.

10. The touch screen panel as claimed in claim 1, wherein, when more than one soft key is to be implemented in the soft key region, each of the soft keys has a corresponding first opening.

11. A display panel, comprising:
a transparent substrate;
a picture region, a black matrix region around the picture region, and a soft key region disposed in a portion of the black matrix region defined on the transparent substrate;
a black matrix formed to correspond to the black matrix region on one side of the transparent substrate and having a first opening in the soft key region;
an overcoating layer on one side of the transparent substrate including the upper portion of the black matrix; and
a metal pattern on the overcoating layer, the metal pattern overlapping the first opening, the metal pattern including a second opening having a smaller area than the first opening, and partially exposing the first opening,
wherein a soft key is implemented in the soft key region by disposing a light source under the first opening and the second opening.
